(19) United States
(12) Patent Application Publication
(10) Pub. No.: US 2004/0166264 A1
(43) Pub. Date: Aug. 26, 2004

(54) Preform assembly, container assembly and method of manufacture

(76) Inventors: Thomas E. Nahill, Amherst, NH (US); Keith J. Barker, Candia, NH (US); Bassam M. Kalmouni, Pembroke, NH (US); Brian A. Lynch, Merrimack, NH (US); Kim D. Lufkin, Auburn, NH (US)

Correspondence Address: OWENS-ILLINOIS, INC., ONE SEAGATE, 25-LDP, TOLEDO, OH, 43666, US

(21) Appl. No.: 10/375,737

(22) Filed: Feb. 26, 2003

(51) Int. Cl. B29C 49/00

(52) U.S. Cl. 428/35.7; 428/542.8; 264/523

(57) ABSTRACT

A method of making a plastic container having a body and a finish with at least one external thread includes providing a plastic preform having a body and a neck and blow molding the body of the preform to form the body of the container. Either prior to or subsequent to blow molding the container body, the preform neck is radially and circumferentially expanded. A finish ring having at least one external thread is secured to the external surface of the neck after expansion of the neck.

The present invention is directed to preforms for blow molding plastic containers, to containers blow molded from such preforms, and to methods of making such preforms and containers.

### BACKGROUND AND SUMMARY OF THE INVENTION

In the manufacture of plastic containers, it is conventional to injection mold or compression mold a container preform having a body and a finish with one or more external threads. The finish typically is molded to its final geometry, while the body of the preform is subsequently blow molded to the desired geometry of the container body. The preform may be of monolayer construction, or may be of multilayer construction in which one or more intermediate layers in the preform body may or may not extend into the finish area of the preform. U.S. Pat. Nos. 4,609,516, 4,710,118 and 4,954,376 illustrate injection molding of multilayer container preforms.

Molding the finish portion of the container as part of the preform presents a number of problems. For example, when the preforms are formed by injection molding, the plastic material typically is injected into a mold cavity at the closed end of the preform body, so that the material must flow along the sides of the preform cavity into the area in which the finish is molded. The finish typically requires more accurate and stable dimensioning than the body of the preform, which may limit the cycle time of the molding process. Furthermore, the finish portion of the preform is of the same material as at least the outer layers of the preform body, which limits the ability to obtain the most desirable characteristics at the finish. When the preform is of polyester construction, such as polyethylene terephthalate (PET), the finish portion of the preform can be wholly or partially crystallized to improve the operating characteristics of the finish area, particularly in hot-fill container applications. However, the requirement that the finish be of the same material as at least the outer layers of the preform body still limits the design capabilities of preform manufacture.

A method of making a plastic container having a body and a finish with at least one external thread, in accordance with a first aspect of the present invention, includes providing a plastic preform having a body and a neck, and blow molding the body of the preform to form the body of the container. Either prior to or subsequent to blow molding the container body, the preform neck is radially and circumferentially expanded. A finish ring having at least one external thread is secured to the external surface of the neck after expansion of the neck.

### BRIEF DESCRIPTION OF THE DRAWINGS

The invention, together with additional objects, features, advantages and aspects thereof, will be best understood from the following description, the appended claims and the accompanying drawings, in which:

FIG. 1 is an elevational view of a container assembly in accordance with an exemplary presently preferred embodiment of the invention;

FIGS. 2A-2D illustrate sequential stages of fabrication of the container of FIG. 1 in accordance with one aspect of the present invention; and

FIGS. 3A-3C illustrate sequential stages of fabrication of the container of FIG. 1 in accordance with another aspect of the present invention.

### DETAILED DESCRIPTION OF PREFERRED EMBODIMENTS

FIG. 1 illustrates a container assembly 10 in accordance with one aspect of the present invention as including a body 12 and a finish 14. Body 12 may be of any suitable geometry, with a cylindrical body being shown for purposes of illustration only. Finish 14 includes suitable closure securement means, such as one or more external threads or thread segments 16. The illustrated finish 14 also includes a bead 18 for cooperating with tamper-indicating means on a closure, and a capping flange 20. In accordance with the present invention, finish 14 is provided separately from container 12, and is externally secured to the neck 22 of container 12 after circumferential and radial expansion of the underlying neck, and either prior to or subsequent to blow molding container body 12. Expansion of the preform neck prior to or subsequent to blow molding the container body has the advantage of at least partially molecularly orienting the neck when the preform is of orientable construction such as PET. Furthermore, throughput of the preform molding operation is increased as compared with molding preforms having enlarged necks.

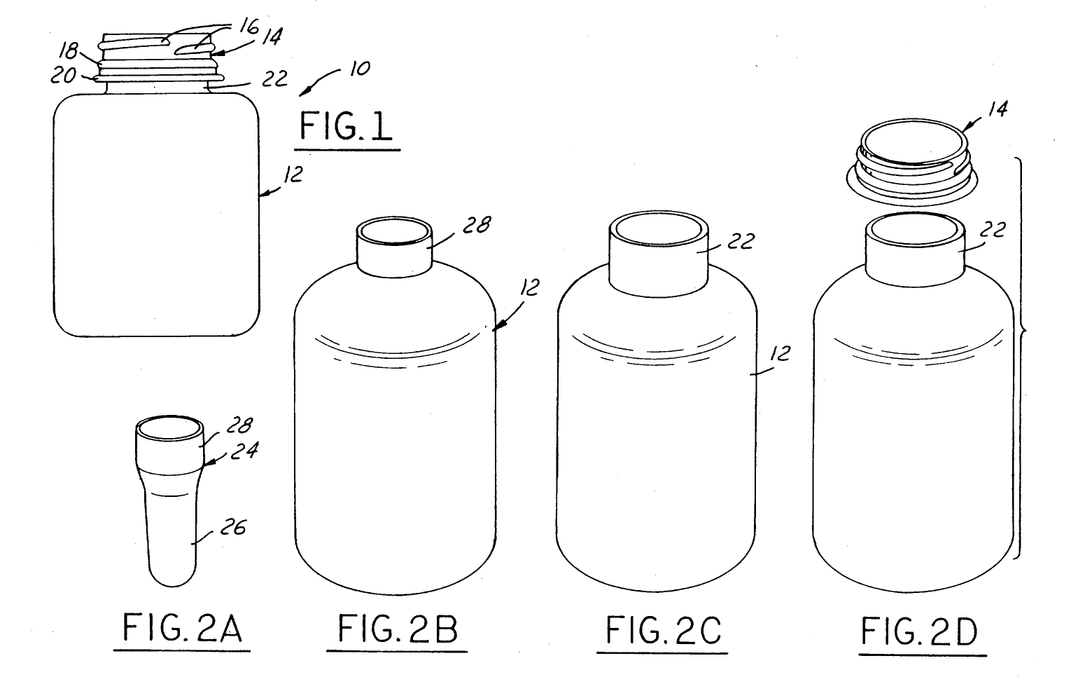

FIGS. 2A-2D illustrate one method of fabricating container 12 in accordance with the present invention. A preform 24 is first formed by injection or compression molding. Preform 24 includes a body 26 that is subsequently blow molded to form body 12 of container 10, and a cylindrical neck 28 that is subsequently expanded to form neck 22 of container 12. In FIG. 2B, preform body 26 has been blow molded to form container body 12, while neck 28 has retained the same geometry as in preform 24. In FIG. 2C, neck 28 has been radially and circumferentially expanded to form final container neck 22. Such radial and circumferential expansion can be accomplished employing any suitable means, such as an expansion cone or chuck, and may be accomplished in single or multiple steps. In FIG. 2D, finish ring 14 is secured over expanded container neck 22. Such finish ring securement can be by interference fit, such as interference press fit or interference shrink fit, by adhesive, by ultrasonic welding or by other suitable technique.

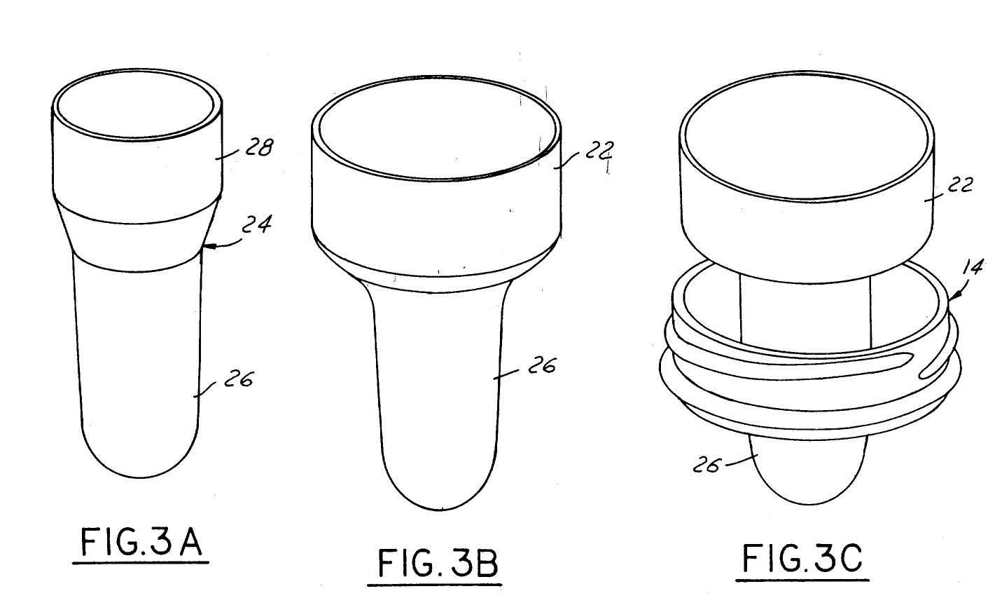

FIGS. 3A-3C illustrate another method of container fabrication. Once again, preform 24 is initially formed in FIG. 3A. However, in this embodiment, preform neck 28 is radially and circumferentially expanded to form container neck 22 prior to blow molding container body 12. Finish ring 14 is then externally secured to expanded preform neck 22 in FIG. 3C, and the preform body is blow molded to form the container body as in FIG. 2B. Finish ring 14 could alternatively be secured to expanded neck 22 subsequent to blowing the container body.

Preform 24 may be of any suitable plastic construction, such as monolayer PET or multilayer construction of PET layers alternating with layers of barrier resin such as ethylene vinyl alcohol (EVOH) or nylon. Preform 24 may be injection molded or compression molded. Likewise, finish ring 14 may be of injection or compression molded plastic construction. By providing finish ring 14 separate from preform 24, finish ring 14 may be of any desired material construction, either the same as or more preferably different from the material construction of the preform. For example, the finish ring can be of PET, post consumer resin (PCR), process regrind (REG), polypropylene (PP), polyethylene (PE) or polyethylene naphthalate (PEN) construction. Where the finish ring is of polyester construction (e.g., PET, PEN or process regrind), the finish ring may be wholly or partially crystallized as molded. This may be accomplished by employing fast-crystallizing materials or suitably setting process conditions for manufacture of the finish ring, such as high mold temperature, slow mold cooling, heated areas in the mold cavity, etc. The finish ring alternatively may be wholly or partially crystallized in a post-molding operation. In other words, the material and conditions of fabrication of the finish ring may be selected separately from the material and manufacturing conditions of the preform to achieve desired operating characteristics at the finish area of the preform and the final container. Furthermore, the preform can be molded with thin wall sections without having to accommodate flow of material into a thicker finish area, which reduces material cost and mold cycle time. The finish ring and/or the preform neck can be provided with suitable means for preventing rotation of the ring on the neck.

There have thus been disclosed a container assembly, a preform assembly, and methods of making the container and preform assemblies that fully satisfy all of the objects and aims previously set forth. The invention has been disclosed in conjunction with two presently preferred embodiments thereof, and other modifications and variations have been discussed. Additional modifications and variations will readily suggest themselves to persons of ordinary skill in the art. The invention is intended to embrace all such modifications and variations as fall within the spirit and broad scope of the appended claims.

1. A method of making a plastic container having a body and a finish with at least one external thread, which comprises the steps of:
(a) providing a plastic preform having a body and a neck,
(b) blow molding said body of said preform to form the body of the container,
(c) either prior to or subsequent to said step (b), expanding said preform neck,
(d) providing a plastic finish ring having at least one external thread, and
(e) securing said finish ring to an external surface of said neck after expansion of said neck in said step (c), and either prior to or subsequent to said step (b).

2. The method set forth in claim 1 wherein said finish ring is externally secured to said neck by interference fit, adhesive, or welding.

3. The method set forth in claim 1 wherein said plastic finish ring is of a different material construction from said plastic preform.

4. The method set forth in claim 1 wherein said plastic finish ring is of material construction selected from the group consisting of: PET, PP, PE, PEN, REG, PCR, and wholly or partially crystallized polyester.

5. A method of making a preform assembly for blow molding a container, which includes the steps of:
(a) providing a molded plastic preform having a body and a cylindrical neck with an external surface,
(b) providing a molded plastic finish ring,
(c) expanding said preform neck, and
(d) securing said finish ring to the external surface of the preform neck after expansion in said step (c).

6. The method set forth in claim 5 wherein said finish ring has at least one external thread and an external capping flange at one axial end of said ring.

7. The method set forth in claim 5 wherein said finish ring is externally secured to said cylindrical neck by interference fit, adhesive, or welding

8. The method set forth in claim 5 wherein said plastic finish ring is of a different material construction from said plastic preform.

9. The method set forth in claim 5 wherein said plastic finish ring is of material construction selected from the group consisting of: PET, PP, PE, PEN, REG, PCR, and wholly or partially crystallized polyester.

10. A plastic container that includes a body and an externally threaded finish,
said finish including a cylindrical neck integrally molded with said body and having a diameter that has been stretched subsequent to molding said neck, and a finish ring with at least one external thread externally secured to said neck.

11. The container set forth in claim 10 wherein said finish ring is externally secured to said neck by interference fit, adhesive, or welding.

12. The container set forth in claim 10 wherein said plastic finish ring is of a different material construction from said plastic preform.

13. The container set forth in claim 10 wherein said plastic finish ring is of material construction selected from the group consisting of: PET, PP, PE, PEN, REG, PCR, and wholly or partially crystallized polyester.

14. A plastic preform assembly that includes:
a molded plastic preform having a body and a cylindrical neck with an external surface,
said neck having been radially and circumferentially expanded subsequent to molding said preform, and
a plastic finish ring molded separately from said preform and externally secured to said neck over said surface.

15. The preform assembly set forth in claim 14 wherein said finish ring is externally secured to said neck by interference fit, adhesive, or welding.

16. The preform assembly set forth in claim 14 wherein said plastic finish ring is of a different material construction from said plastic preform.

17. The preform assembly set forth in claim 14 wherein said plastic finish ring is of material construction selected from the group consisting of: PET, PP, PE, PEN, REG, PCR, and wholly or partially crystallized polyester.
